(19) United States
(12) Patent Application Publication
(10) Pub. No.: US 2005/0057713 A1
(43) Pub. Date: Mar. 17, 2005

(54) Transflective film and liquid crystal display device

(75) Inventors: Takahito Mafune, Fukushima-ken (JP); Manabu Kusano, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/935,324

(22) Filed: Sep. 7, 2004

(30) Foreign Application Priority Data
Sep. 11, 2003 (JP) 2003-319989

(51) Int. Cl. G02F 1/1335

(52) U.S. Cl. 349/114

(57) ABSTRACT

In a transflective layer constituting a transflective film, transmitting openings are formed beyond a portion corresponding to a display region of the liquid crystal display panel in which pixels are formed. In this way, the transmitting openings are formed beyond a portion corresponding to a display region of the liquid crystal display panel, so that the generation of stains or whitened portions on the reflecting surface during the process for forming the transflective layer can be prevented.

### BACKGROUND OF THE INVENTION

1. Field of the Invention

The present invention relates to a transflective film and a liquid crystal display device.

2. Description of the Related Art

In portable electronic apparatuses such as a wireless phone and a gaming machine, since the lifetime of battery largely effects various operating conditions, a transflective liquid crystal display device capable of consuming low power is commonly provided as a display unit. Such a transflective liquid crystal device comprises a transflective film, which entirely reflects external light incident from a front surface thereof and transmits light from a backlight provided on a rear side of a liquid crystal display panel.

The transflective film is usually made of a metal film having a reflecting surface and a plurality of transmitting openings for transmitting light. According to such a construction, it is possible to reflect external light incident from outside on the surface and to transmit illumination light from the backlight through the surface of the transflective film.

For example, in the transflective liquid crystal device disclosed in Patent Document 1 (Japanese Unexamined Patent Application Publication No. 2003-215591), a transflective reflector in which a plurality of concave portions are formed on the surface thereof is disclosed as a reflector for reflecting light transmitted through the liquid crystal layer.

Such a transflective film has been made by forming a mask pattern on a metal film and performing an etching process to form transmitting openings in the metal film. On a part of the transflective film formed by etching process, stains or whitened portions are generated. The reflectance of the transflective film having the stains or whitened portions typically decreases, which consequently deteriorates the visibility of the liquid crystal display panel. Especially, when the transflective film faces the liquid crystal display panel, the stains or whitened portions are markedly generated on the regions near the periphery of the display region of the liquid crystal display panel.

Further, an unevenness-occurring film made from acrylic resin, or epoxy resin that cause the diffusion effect under the reflecting film is covered on the reflecting layer, which leaves etching gas and uncured components inside the resin layer. Such etching gas and uncured components are considered as a cause of stains or whitened portions.

The present invention has been made in consideration of the above-mentioned problems, and an object of the invention is to provide a liquid crystal display device comprising a transflective film, which is capable of satisfactorily maintaining the surface reflectance.

### SUMMERY OF THE INVENTION

To achieve the above-mentioned object, in the present invention, a transflective film is formed inside or outside of a liquid crystal display panel and has a plurality of transmitting openings formed on a surface thereof. The transmitting openings are formed in an outer peripheral region outside of a portion, which faces the display region of the liquid crystal display panel, in addition to being formed in the display region.

The transflective film may have a plurality of fine concave portions on the surface thereof. Further, a liquid crystal display device comprising the transflective film, a liquid crystal display panel, and an illuminating device is provided.

According to the above-mentioned transflective film, the transmitting openings are formed beyond the portion corresponding to the display region of the liquid crystal display panel in which pixels are formed, such that the remaining gas is effectively removed, and uncured components are eliminated. Therefore, it is possible to suppress the generation of stains and whitened portions on a part of the transflective film, and to highly maintain the reflectance of the transflective film.

Fine concave portions formed on the surface of the transflective film are useful for effectively reflecting incident light. According to a liquid crystal display device comprising the above-mentioned transflective film, a liquid crystal display panel, and an illuminating device, it is possible to secure the clear visibility with high brightness with respect to the external light.

### BRIEF DESCRIPTION OF THE DRAWINGS

FIG. 1 is a sectional view illustrating the principal parts of a liquid crystal display device comprising a transflective film according to the present invention.

FIG. 2 is a perspective view illustrating the principal parts of the construction of the transflective film according to the present invention.

FIG. 3 is a sectional view illustrating the principal parts of the liquid crystal display device comprising the transflective film according to the present invention.

FIG. 4 is a view illustrating the relationship between the transflective film and liquid crystal display panel according to the present invention.

### DESCRIPTION OF THE PREFERRED EMBODIMENT

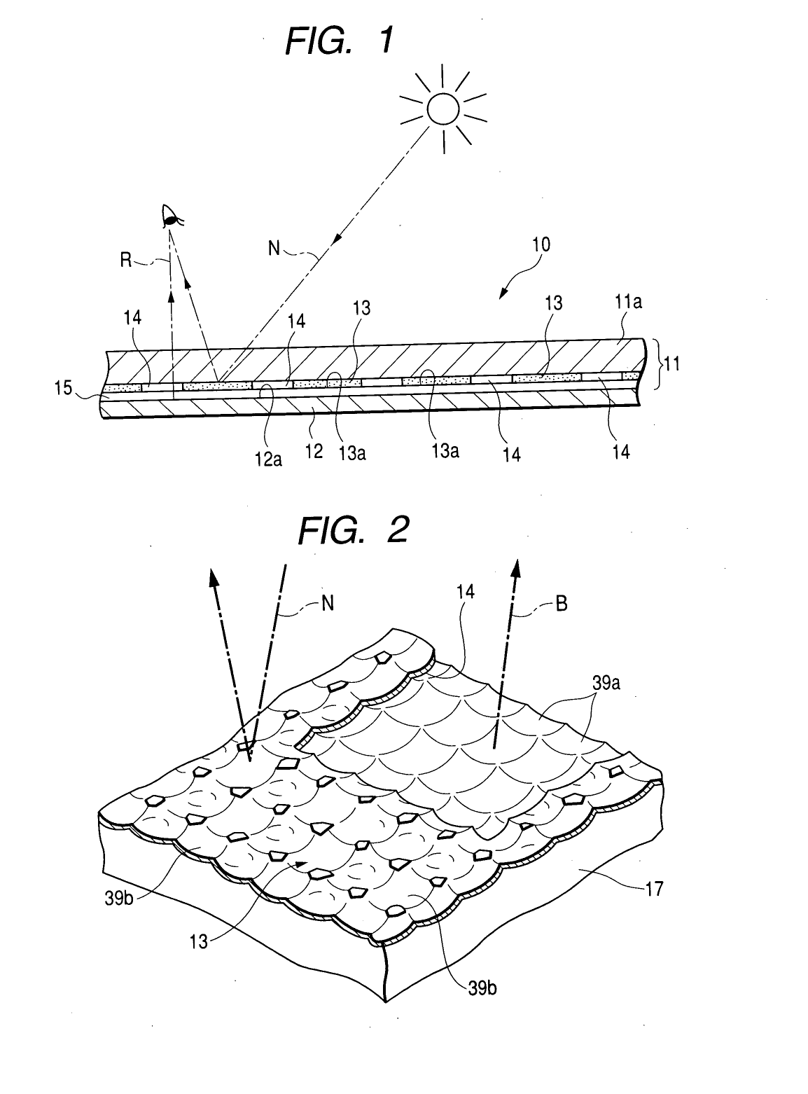

Hereinafter, the preferred embodiment of the present invention will be described. FIG. 1 is a sectional view illustrating the principal parts of a liquid crystal display device comprising a transflective film according to the present invention. The liquid crystal display device 10 comprises a liquid crystal display panel 11 and an illuminating device (a back light) 12. The liquid crystal display panel 11 comprises a transflective film 13 interposed between an upper layer 11a having a liquid crystal layer and a first substrate and a lower layer having a second substrate.

The liquid crystal display panel 11 can display clearly characters and figures by the illumination from the lower layer side using the illuminating device 12. The illuminating device 12 may comprise a light source such as a light emitting diode and a light guider, which spreads light from the light source to approximately the same area as the display region. The illuminating device 12 illuminates uniformly illumination light toward the liquid crystal display panel 11 from the total light emitting surface 12a thereof.

Transmitting openings 14 are formed on the transflective film 13 at regular intervals. The transflective film 13 reflects light on a reflecting surface 13a, and transmits light through transmitting openings 14. As illustrated FIG. 1, between the upper layer 11a and the lower layer 15 of the liquid crystal display panel 11, the transflective film 13 reflects external light N, which transmits the liquid crystal display panel 11, on the reflecting surface 13a to illuminate the liquid crystal display panel 11. Further, the transflective film 13 transmits illumination light R emitted from the light emitting surface 12a of the illuminating device 12 through the transmitting opening 14 to illuminate the liquid crystal display panel 11 from the rear side thereof.

According to the reflecting and transmitting operation of the transflective film 13, when it is used in outdoors having an abundant external light, the transflective film 13 clearly illuminates the liquid crystal display panel 11 by reflecting the external light which is incident on the liquid crystal-display panel 11. Also, when it is used in an environment such as in indoors or at night where external light is lacking, the illuminating device is turned on, and illuminating light emitted from the light emitting surface 12a transmits the transmitting openings 14 to clearly illuminate the liquid crystal display panel 11.

The transflective film 13 can clearly illuminate the liquid crystal display panel 11 by external light or the illuminating device, so that the power required by the illuminating device is decreased to reduce the battery consumption.

FIG. 2 is an enlarged exploded perspective view illustrating the transflective film of the liquid crystal display panel illustrated in FIG. 1. The transflective film 13 has a plurality of transmitting openings 14 on the surface thereof. The transflective film 13 is preferably made of aluminum or aluminum based alloy thin film having the thickness of 1000 Å to 2000 Å. A part of the top surface of the transflective film in which the transmitting openings 14 are not formed becomes a reflecting surface to reflect incident light (arrow N in the figure). The transmitting openings 14 may be formed as through-holes having a rectangular-shaped opening surface. The transmitting openings 14 transmit light from the illuminating device 12 (arrow B in the figure).

The transmitting openings 14 may be formed to have a surface area ratio of 15% to 50%, more preferably 25% to 45% to the area of one surface of the transflective film 13. Further, the transmitting openings 14 formed on the transflective film 13 may have a hexagonal-shaped or circular-shaped opening surface.

A resin layer 17 made of acryl, epoxy modified acryl, epoxy, urethane, and so on, is formed on the lower surface of the transflective film 13. Fine concave portions 39a are randomly formed on a surface of the resin layer 17. The fine concave portions 39a form concave portions 39b on the surface of the transflective film 13. Fine concave portions 39a are previously formed on the resin layer 17, and the concave portions 39b are formed on the transflective film 13 by laminating the transflective film thereon.

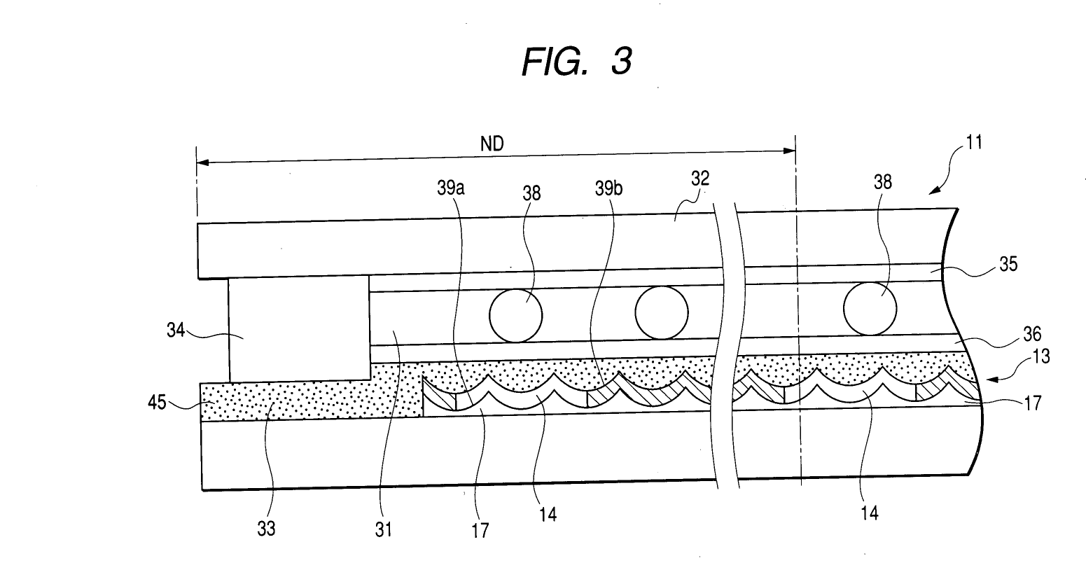

FIG. 3 is an enlarged sectional view illustrating in detail the liquid crystal display panel 11 and the transflective film 13. The liquid crystal display panel 11 is a transflective liquid crystal display panel integrally formed by bonding a first substrate 32 and a second substrate 33, which face each other, by sealing material 34. A liquid crystal layer 31 is interposed between the first substrate 32 and the second substrate 33. A display circuit 35, which driving-controls liquid crystal layer and has an electrode and an alignment film, is provided on a surface the first substrate 32 which faces the liquid crystal layer 31. A display circuit 36, which driving-controls liquid crystal layer and has an electrode and an alignment film, is provided on a surface the second substrate 33 which faces the liquid crystal layer 31.

Further, a plurality of spacers 38 are provided between the display circuit 35 and the display 36 to maintain regular intervals therebetween. And, the transflective film 13 is formed between the first substrate 32 and the second substrate 33. An overcoat layer 45 is laminated on the top surface of the transflective film 13.

The fine concave portions 39b formed on the transflective film 13 effectively reflects again external light, which transmits the liquid crystal layer 31 and enters the transflective film 13, toward the liquid crystal. The width ND of non-display area of the edge portion of the liquid crystal display panel 11 may be, for example, 1 mm to 4.5 mm. When ND is no more than 1 mm, it is undesirable in that the area for a seal pattern and for winding an electrode is not secured. When ND is no less than 4.5 mm, it is undesirable in that the miniaturation (narrow picture frame) is difficult.

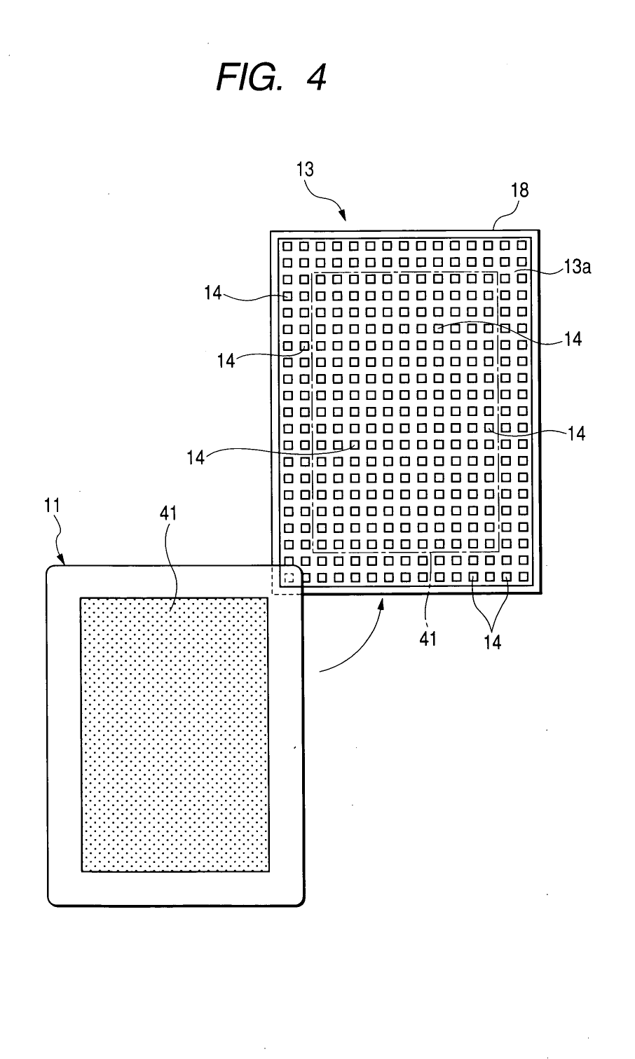

As illustrated in FIG. 4, in the transflective layer 18 constituting the transflective film 13, the transmitting openings 14 are formed beyond a portion (a region dashed by one-dotted line in FIG. 4) corresponding to a display region 41 of the liquid crystal display panel 11 in which pixels are formed. In this way, the transmitting openings 14 are formed beyond a portion corresponding to a display region 41 of the liquid crystal display panel 11, so that the generation of stains or whitened portions on the reflecting surface 13a during forming the transflective layer 18 can be prevented.

The generation of the above stains or whitened portions are considered due to remaining gas or uncured resin portion generated in the resin layer 17 during process for forming the transflective layer 18. However, the openings are provided in the vicinity of the part where the stains or whitened portions are generated by also forming the transmitting openings 14 outside the portion corresponding to the display region 41, so that the remaining gas is removed and the generation of the stains or whitened portions on the reflecting surface 13a of the peripheral portion in plan view is suppressed.

Therefore, in the transflective layer 18, the transmitting openings 14 are formed beyond a portion corresponding to a display region 41 of the liquid crystal display panel 11 in which pixels are formed, so that it is possible to suppress the generation of stains or whitened portions on the reflecting surface, and to highly maintain the reflectance of the transflective layer 18.

Further, according to the above-described embodiment, the transflective film is mounted within the liquid crystal display panel. The present invention is not limited thereto, the transflective film may be formed between the liquid crystal display panel and the illuminating device, or on the light-emitting surface of the illuminating device.

1. A transflective film which is formed inside or outside of liquid crystal display panel and has a plurality of transmitting openings formed on a surface thereof,
wherein the transmitting openings are formed in a periphery region outside of a portion, that faces the display region of the liquid crystal display panel in addition to being formed in the display region.

2. The transflective film according to claim 1,
wherein a plurality of fine concave portions are formed on the surface of the transflective film.

3. The transflective film according to claim 1,
wherein a width of non-display area in an edge portion of the liquid crystal display panel is about 1 mm to 4.5 mm.

4. The transflective film according to claim 1,
wherein a ratio of an area of the transmitting openings to an area of one surface of the transflective film is about 15% to 50%.

5. The transflective film according to claim 1,
wherein a ratio of an area of the transmitting openings to an area of one surface are transflective film is about 25% to 45%.

6. The transflective film according to claim 1,
wherein the transmitting openings are formed at regular intervals.

7. The transflective film according to claim 1,
wherein the transmitting openings are through-holes having a rectangular shape.

8. The transflective film according to claim 1,
wherein transflective film is made of aluminum or aluminum based alloy thin film having a thickness of about 1000 Å to about 2000 Å.

9. A liquid crystal display device comprising a liquid crystal display panel having a transflective film according to claim 1, and an illuminating device, which illuminates the display panel from the rear surface thereof.

10. The liquid crystal display device according to claim 9,
wherein an overcoat layer is laminated on a top surface of the transflective film.
